(19) United States
(12) Patent Application Publication
(10) Pub. No.: US 2007/0173361 A1
(43) Pub. Date: Jul. 26, 2007

(54) TRACTION-MECHANISM DRIVE

(75) Inventor: Bolko Schuseil, Adelsdorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/624,283

(22) Filed: Jan. 18, 2007

(30) Foreign Application Priority Data
Jan. 25, 2006 (DE) 102006003461.9

(51) Int. Cl. F16H 7/00

(52) U.S. Cl. 474/87

(57) ABSTRACT

A traction-mechanism drive is provided including a drive crankshaft and a traction-mechanism wheel, especially a belt or chain wheel, located on the crankshaft. At least one other shaft is integrated into the drive via a traction-mechanism wheel, especially a belt or chain wheel, and also a traction mechanism, especially a belt or chain, is guided over the traction-mechanism wheels. One of the traction-mechanism wheels (7), which is integrated into the drive (1) to compensate for first-order spurious vibrations introduced into the drive (1) via one of the shafts (6), is round and arranged eccentric (e) to the shaft rotational axis (M_{W}).

### BACKGROUND

The invention relates to a traction-mechanism drive comprising a crankshaft driving the drive and a traction-mechanism wheel, especially a belt or chain wheel, and also at least one other shaft integrated into the drive via a traction-mechanism wheel, especially a belt or chain wheel, and also a traction mechanism, especially a belt or a chain, guided over the traction-mechanism wheels.

Such traction-mechanism drives are used in a plurality of known work machines, especially internal combustion engines in the automotive industry. The drive itself is driven by a crankshaft, which is part of, for example, an internal combustion engine. Other various shafts, for example, a camshaft, a shaft for an air-conditioner compressor, etc., or else also balance shafts, especially for diesel engines, are integrated into the drive via the traction mechanism. Such traction-mechanism drives have been known for a long time.

It is also known that spurious vibrations are introduced into these drives via one or another integrated shaft, that is, periodically varying vibrations, which lead to fluctuations of the force acting on the traction mechanism, that is, for example, the belt or the chain, as a function of their frequency and amplitude. These force vibrations lead to non-uniform and excess loading of the traction mechanism and are the source for a relatively erratic and noisy running of the crankshaft drive, which can have an effect on automotive engines that is noticed by the driver.

For compensating these spurious vibrations, it is known to configure one or more of the traction-mechanism wheels so that it is non-round, for example, oval, in order to introduce target counter or compensating vibrations into the traction-mechanism drive. These counter or compensating vibrations are used to compensate for the unintentionally produced spurious vibrations introduced via the crankshaft coupled to the engine, thus to partially or completely eliminate these spurious vibrations. By the use of such non-round, as described primarily oval, wheels, however, it is possible to generate only counter vibrations of higher order or to compensate only smooth spurious vibrations of higher order, that is, of second order or higher. However, first-order spurious vibrations are also responsible for the non-uniform running of the drive and the resulting excess loading of the traction mechanism, wherein, below, these spurious vibrations are understood to be introduced into the gear train once for each 360° rotation of the shaft generating or introducing the spurious vibration, for example, the crankshaft or a balance shaft or the like. In the state of the art, non-round wheels having oval or other geometries are not and cannot be damped.

### SUMMARY

The invention is based on the objective of providing a traction-mechanism drive, which also provides a possibility for damping first-order spurious vibrations.

To meet this objective, for a traction-mechanism drive of the type named above, it is provided that one of the traction-mechanism wheels integrated into the drive for compensating first-order spurious vibrations introduced into the drive via one of the shafts is round and arranged eccentric to the rotational axis of the shaft.

For the traction-mechanism drive, the first-order spurious vibrations are compensated by an eccentric positioning of one of the traction-mechanism wheels, which itself is round. The eccentric traction-mechanism wheel is preferably arranged naturally on the shaft, which introduces the first-order spurious vibration to be damped into the drive. Due to the fixed connection of this eccentric wheel to the shaft, a varying force is mechanically given to the traction mechanism as a function of the degree of eccentricity for each 360° rotation of this shaft. This configuration generates a vibration. The degree of eccentricity is to be selected so that the most optimum damping possible is achieved relative to the considered range of rotational speed of the drive.

Consequently, due to the eccentric arrangement of a round traction-mechanism wheel, a certain first-order spurious vibration is also compensated for the traction-mechanism drive according to the invention. Obviously, higher-order vibrations can still be compensated via non-round wheels, for example, an oval wheel arranged on the crankshaft.

The shaft introducing the spurious vibration to be damped by the traction-mechanism drive according to the invention, preferably as a first-order spurious vibration, is typically a balance shaft. Such balance shafts are used primarily in internal-combustion engines, especially in the crankshaft drive for diesel engines. In these drives, the crankshaft itself causes higher-order spurious vibrations due to their direct coupling with the motor or the piston, depending on the piston movement. The balance shaft is used for steadying the crankshaft drive with reference to the effective free moments of inertia and forces of gravity. It represents, to some extent, an unbalanced mass, which is deliberately integrated in the drive and which compensates for at least one portion of these free moments of inertia and forces of gravity. It is driven, as described, via the crankshaft, but, due to its own shaft mass, it introduces a spurious vibration spectrum into the drive, which also exhibits a first-order spurious vibration. In particular, such a first-order spurious vibration resulting from a balance shaft can be effectively damped with the traction-mechanism drive according to the invention, wherein preferably the traction-mechanism wheel sitting directly on the balance shaft is arranged eccentrically relative to the balance shaft rotational axis.

As described, the amplitude and phase position of the generated counter vibration must be selected with the most optimal values in terms of the first-order spurious vibration to be damped in order to be able to effectively damp these spurious vibrations. For this reason, for one, the degree of eccentricity, that is, how far the center of the traction-mechanism wheel is shifted from the rotational axis, is to be selected as a function of the spurious vibration to be damped. In addition, however, the angular position of the eccentricity also must be defined correctly, so that the counter vibration is introduced at the correct time, that is, the correct phase position, relative to the spurious vibration. Because the drive is driven via the crankshaft, it is preferable to select the angular position of the eccentric traction-mechanism wheel as a function of the position of the crankshaft. This means that the angular offset of the eccentric traction-mechanism wheel, for example, on the balance shaft, is defined relative to a certain position of the crankshaft or a certain angular position of the crankshaft, e.g., its position in the top dead center point.

### BRIEF DESCRIPTION OF THE DRAWINGS

Additional advantages, features, and details of the invention emerge from the following description of a preferred embodiment. Shown are:

FIG. 1 is a block diagram of a traction-mechanism drive according to the invention, and

FIGS. 2 and 3 are two diagrams, which show the tensile force versus the rotation of the crankshaft for the loose-section side and the tensed-section side, as a comparison between a centered wheel and an eccentric wheel.

### DETAILED DESCRIPTION OF THE PREFERRED EMBODIMENTS

The invention shows, in the form of a block diagram, a traction-mechanism drive 1 according to the invention, comprising a crankshaft 2 with a round traction-mechanism wheel 3 sitting centered on the crankshaft, another shaft 4, which can be of any type with a round, centered traction-mechanism wheel 5, and also in the shown example a balance shaft 6 with a round traction-mechanism wheel 7 sitting eccentrically on this balance shaft. The traction-mechanism drive 1 is driven via the crankshaft 2, which is, for example, part of an internal combustion engine, in the direction of the arrow P. The traction mechanism 8, for example, a belt or a chain, rotates in the direction of the arrow R. The tensed section Z is located between the eccentric traction-mechanism wheel 7 on the balance shaft 6 and the centered traction-mechanism wheel 3 of the crankshaft 2. The loose section L is located between the crankshaft wheel 3 and the traction mechanism wheel 5.

During operation, via the balance shaft 6, a spurious vibration spectrum comprising a first-order spurious vibration is introduced into the traction-mechanism drive 1, which leads to a periodic fluctuation of the tensile force acting on the traction mechanism 8 in the tensed section Z as in the loose section L. This induced first-order spurious vibration can be compensated via the eccentric arrangement of the traction mechanism wheel 6. It can be seen that the center point M_{Z} of the traction-mechanism wheel 7 is offset from the center point M_{W} of the balance shaft 6 by the eccentricity e. For a 360° rotation of the balance shaft 6, this arrangement leads to a periodically fluctuating force being introduced into the traction-mechanism drive or into the traction mechanism 8. The degree of eccentricity, and also the angular position of the eccentricity, is now selected so that the most effective compensation or damping possible is realized relative to the actual loading of the traction mechanism by the first-order spurious vibration to be damped or its amplitude and phase position. As a reference point for the angular offset of the arrangement of the eccentric traction-mechanism wheel 7, preferably the angular position of the crankshaft 2, through which the general drive of the traction-mechanism drive 1 is performed, is selected. In the illustrated example, the crankshaft is shown in a position, in which it is positioned in the top dead center point OT. The angular offset of the eccentricity e is here selected, for example, by an angle α, relative to the instantaneous position of the crankshaft 2 in its angular position in the top dead center point OT. During a 360° rotation of the crankshaft 2 and thus of the crankshaft wheel 3, the balance shaft performs two rotations due to the different radii of the traction-mechanism wheels 3 and 7. During each 360° rotation of the balance shaft 6, for one the first-order spurious vibration to be damped is introduced, second, the full eccentric wheel path is also traveled once due to the 360° rotation, and thus always generates, for each introduced spurious vibration, the counter vibration due to the direct arrangement of the eccentric traction-mechanism wheel 7 on the balance shaft 6 here assumed to be introducing the spurious vibration to be damped.

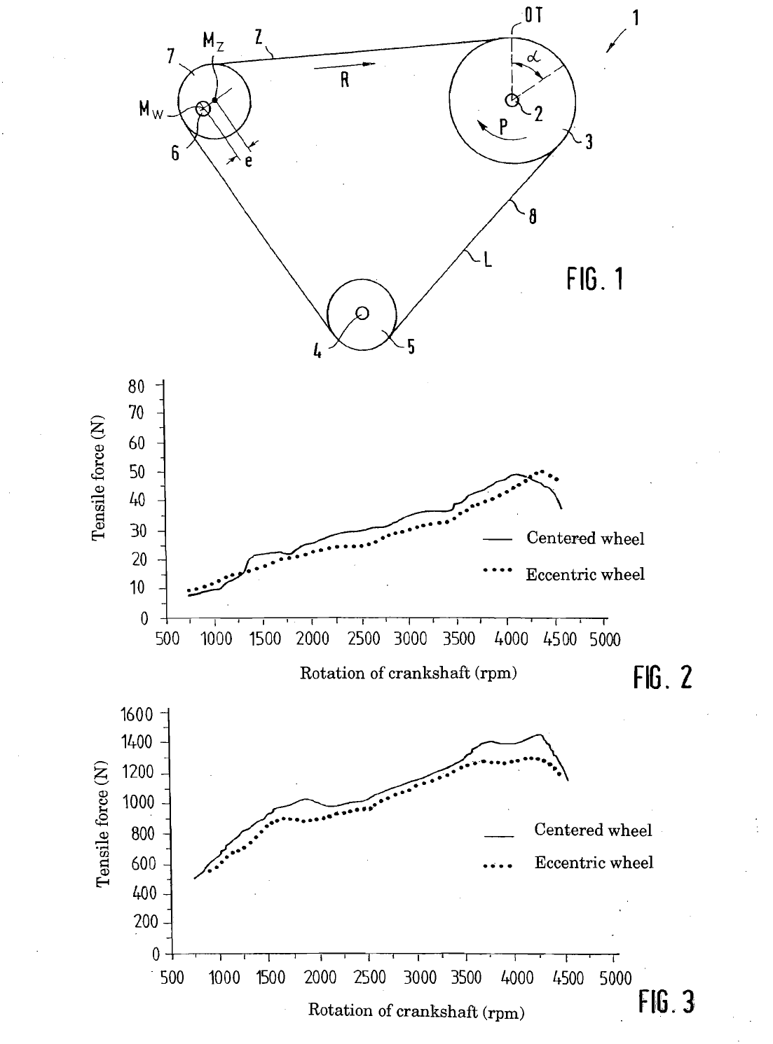

FIGS. 2 and 3 show the basic effectiveness of such an eccentric arrangement using examples. In these figures, the rotational speed of the crankshaft in rpm is plotted along the abscissa and the tensile force exerted on the loose section (FIG. 2) and on the tensed section (FIG. 3), respectively, is plotted, along the ordinate. In each of these figures, a solid line shows the force profile for an arrangement of a round, but centered traction-mechanism wheel, in the shown example on the balance shaft 6, while a dashed line shows the force profile for an eccentric arrangement of the traction-mechanism wheel, offset by the eccentricity e and relative to the crankshaft position about the angle α, as FIG. 1 shows with an example. As can be seen, the dashed line, which represents the force profile for the use of the eccentric traction-mechanism wheel, lies below the curve for the use of a centered wheel in approximately all of the rotational speed ranges. This means that the effective tensile force can be reduced, both in the loose section L and also in the tensed section Z. This effect is traced back just to the damping of the first-order spurious vibration.

FIGS. 2 and 3 are only of an exemplary nature. Obviously, the degree of damping can be varied according to the configuration of the actual traction-mechanism drive, as a function of the degree of the selected eccentricity e, as well as the selected angle α or the actually selected angular position relative to the crankshaft.

### REFERENCE SYMBOLS

1 Traction-mechanism drive
2 Crankshaft
3 Traction-mechanism wheel
4 Additional shaft
5 Traction-mechanism wheel
6 Balance shaft
7 Traction-mechanism wheel
8 Traction mechanism
P Arrow
R Arrow
Z Tensed section
L Loose section
M_{Z} Center of traction-mechanism wheel
M_{W} Center of balance shaft
e Eccentricity
OT Top dead center point
N Tensile force

1. Traction-mechanism drive comprising a drive crankshaft having a traction-mechanism wheel attached thereto, at least one additional shaft integrated into the drive via a second traction-mechanism wheel mounted thereon, and a traction mechanism guided over the traction-mechanism wheels, at least one of the traction-mechanism wheels, which compensates for first-order spurious vibrations introduced into the drive via one of the shafts, is round and arranged eccentric to a rotation axis of the shaft upon which it is mounted.

2. Traction-mechanism drive according to claim 1, wherein the shaft that introduces the spurious vibration is a balance shaft.

3. Traction-mechanism drive according to claim 2, wherein the second traction-mechanism wheel located on the balance shaft is arranged eccentric to the rotational axis of the balance shaft.

4. Traction-mechanism drive according to claim 1, wherein an angular position of the eccentrically mounted traction-mechanism wheel is selected as a function of a position of the crankshaft.

5. Traction-mechanism drive according to claim 1, wherein the traction mechanism wheels comprise a belt or chain wheel, and the traction mechanism comprises a belt or a chain.
